(19) United States
(12) Patent Application Publication
(10) Pub. No.: US 2021/0300435 A1
(43) Pub. Date: Sep. 30, 2021

(54) MANAGEMENT DEVICE, TRANSPORTATION SYSTEM, MANAGEMENT METHOD, AND RECORDING MEDIUM

(71) Applicant: HONDA MOTOR CO., LTD., Tokyo (JP)

(72) Inventors: Yurie Kondo, Tokyo (JP); Kensaku Yamamoto, Wako-shi (JP); Ryohei Iwaki, Wako-shi (JP); Yusuke Kawada, Wako-shi (JP)

(21) Appl. No.: 17/167,117

(22) Filed: Feb. 4, 2021

(30) Foreign Application Priority Data
Mar. 31, 2020 (JP) 2020-061997

(51) Int. Cl. B60W 60/00; G06K 9/00; B60R 5/04; B60P 3/00; G06Q 10/08

(52) U.S. Cl. CPC B60W 60/00256; G06K 9/00832; B60W 2420/42; B60P 3/00; G06Q 10/0832; B60R 5/044

(57) ABSTRACT

A management device is configured to manage an operation of a luggage transporting vehicle, the luggage transporting vehicle being configured to autonomously travel a road without a driver being aboard and comprising a luggage containment part which is shielded by a door part that is able to be opened and closed, the management device including: an acquisition part configured to acquire an image of an inside of the containment part, and a determination part configured to determine whether a delivery of a luggage contained in the containment part has been completed normally on the basis of the image.

### CROSS-REFERENCE TO RELATED APPLICATION

Priority is claimed on Japanese Patent Application No. 2020-061997, filed Mar. 31, 2020, the content of which is incorporated herein by reference.

### BACKGROUND OF THE INVENTION

### Field of the Invention

The present invention relates to a management device, a transportation system, a management method, and a recording medium.

### Description of Related Art

An invention related to an autonomous mobile apparatus that is autonomously movable and an unmanned delivery system configured to deliver luggage using a server system operated in relation therewith has been disclosed (Japanese Unexamined Patent Application, First Publication No. 2018-058656).

### SUMMARY OF THE INVENTION

In the related art, it is difficult to check whether delivery of luggage has been completed normally, and the convenience is not sufficient.

An aspect of the present invention is directed to providing a management device, a transportation system, a management method, and a recording medium that are capable of improving convenience.

A management device, a transportation system, a management method, and a recording medium according to the present invention employ the following configurations.

(1) A management device according to an aspect of the present invention is a management device configured to manage an operation of a luggage transporting vehicle, the luggage transporting vehicle being configured to autonomously travel a road without a driver being aboard and including a luggage containment part which is shielded by a door part that is able to be opened and closed, the management device including: an acquisition part configured to acquire an image of an inside of the containment part; and a determination part configured to determine whether a delivery of a luggage contained in the containment part has been completed normally on the basis of the image.

(2) In the aspect of the above-mentioned (1), the management device may further include a writing part configured to write the image of a scene in which the luggage has been unloaded into a storage, among the images acquired by the acquisition part.

(3) In the aspect of the above-mentioned (2), the writing part may not perform writing of the image when the determination part determines that the delivery has been completed normally.

(4) In the aspect of the above-mentioned (1) to (3), the acquisition part may acquire weight information related to a weight of the luggage contained in the containment part, and the determination part may determine whether delivery of the luggage contained in the containment part has been completed normally also on the basis of the weight information acquired by the acquisition part.

(5) In the aspect of any one of the above-mentioned (1) to (4), the determination part may determine whether delivery of the luggage contained in the containment part has been completed normally when a movement of the luggage transporting vehicle is restricted by a restricting tool.

(6) A transportation system according to another aspect of the present invention is a transportation system including the management device and the luggage transporting vehicle according to any one of the above-mentioned aspects (1) to (5), wherein the luggage transporting vehicle includes a camera configured to image the inside of the containment part, and generates an image captured by the camera and outputs the image to the management device.

(7) In the aspect of the above-mentioned (6), the transportation system may further include an external control device that is provided outside the luggage transporting vehicle and that is configured to transmit operation information to the luggage transporting vehicle and remotely control the luggage transporting vehicle, wherein the external control device remotely operates the luggage transporting vehicle when there is a problem in a managing of the operation of the luggage transporting vehicle by the management device.

(8) In the aspect of the above-mentioned (6) or (7), the transportation system may include a request part configured to request closing of the door part provided in the containment part in which the luggage was contained, when the delivery of the luggage has been completed, wherein, when a first user who has unloaded the luggage from the containment part did not close the door part, the request part requests a second user to whom a luggage was delivered next after the first user to close the door part.

(9) In the aspect of the above-mentioned (6) or (7), the transportation system may include a request part configured to request closing of the door part provided in a containment part in which luggage was contained, when the delivery of the luggage has been completed; and an assigning part configured to assign a reward to a person who has closed the door part, wherein, when an user who has unloaded the luggage from the containment part does not close the door part, the request part requests another person other than the user to close the door part, and the assigning part assigns the reward to the another person when the another person has closed the door part in response to the request of the request part.

(10) A management method according to another aspect of the present invention is a management method of a management device, the management device being configured to manage an operation of a luggage transporting vehicle which autonomously travels a road without a driver being aboard and which comprises a luggage containment part shielded by a door part that can be opened and closed, the management method comprising operation controls of the management device in which: acquiring an image obtained by imaging the inside of the containment part; and determining whether a delivery of a luggage contained in the containment part has been completed on the basis of the image.

(11) A computer-readable recording medium according to another aspect of the present invention is a computer-readable recording medium on which a program is stored, the program including operation controls of a management device, which is configured to manage an operation of a luggage transporting vehicle that autonomously travels a road without a driver being aboard and that comprises a luggage containment part shielded by a door part that can be opened and closed, in which acquiring an image obtained by imaging the inside of the containment part; and determining whether a delivery of a luggage contained in the containment part has been completed on the basis of the image.

According to the aspects of the above-mentioned (1) to (11), convenience can be improved.

### BRIEF DESCRIPTION OF THE DRAWINGS

FIG. 1 is a configuration view of a transportation system including a management device.

FIG. 2 is a configuration view of a luggage transporting vehicle.

FIG. 3 is a view showing an example of a structure related to a plurality of containment parts.

FIG. 4 is a view showing an example of an internal structure of the containment part.

FIG. 5 is a side view showing a regulating tool.

FIG. 6 is a configuration view of the management device.

FIG. 7 is a view conceptually showing contents of movement schedule information.

FIG. 8 is a flowchart showing an example of processing of the luggage transporting vehicle.

FIG. 9 is a flowchart showing an example of processing of a delivery processing part.

FIG. 10 is a configuration view of a transportation system including a management device according to a second embodiment.

FIG. 11 is a flowchart showing an example of processing of a monitoring device.

### DETAILED DESCRIPTION OF THE INVENTION

Hereinafter, embodiments of a management device, a management method, and a recording medium of the present invention will be described with reference to the accompanying drawings. A luggage transporting vehicle managed by the management device is capable of autonomously traveling on a road without a driver being on board, and has a plurality of luggage containment parts shielded by door parts that can be opened and closed.

The luggage transporting vehicle recognizes situations outside the vehicle using a monitoring unit such as a camera, a radar device, a light detection and ranging (LIDAR), or the like, and in principle, moves on a road by avoiding obstacles on the road while following a route instructed by the management device. The luggage transporting vehicle moves on the road at a speed of about 10 [km/h] as wheels are driven by, for example, a motor. For example, the containment part units of the luggage transporting vehicle form a plurality of luggage carrying spaces (enabling parts) partitioned from other spaces, and allow a plurality of users to load (carry in) their luggage.

The management device manages (controls) an operation of the luggage transporting vehicle. The management device may be a device located at a place different from the luggage transporting vehicle and able to communicate with the luggage transporting vehicle via a network, or some or all of the functions may be installed on the luggage transporting vehicle. The management device generates, for example, transportation schedule information on the basis of request information acquired by communication from a terminal device of a user. Then, the management device gives instructions regarding a route or a stopping place of the luggage transporting vehicle, an open/closed state of a door of the containment part, and the like, to the luggage transporting vehicle on the basis of the transportation schedule information.

In the following description, the management device is a device located at a place different from the luggage transporting vehicle (for example, a device referred to as a cloud server), and configured to realize functions through communication with the terminal device of the user or the luggage transporting vehicle via a network.

### First Embodiment

First a first embodiment will be described.

### [Entire Configuration]

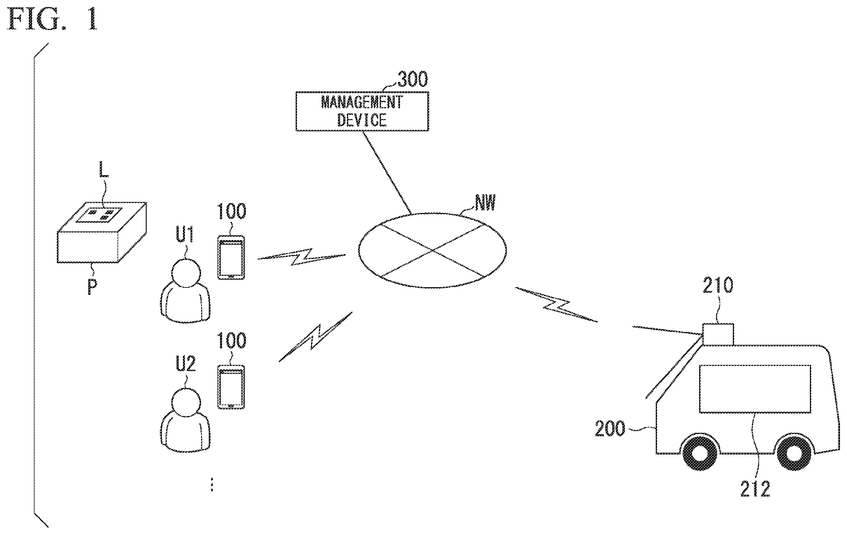

FIG. 1 is a configuration view of a transportation system 1 including a management device 300. The transportation system 1 includes one or more luggage transporting vehicles 200 and the management device 300. The management device 300 communicates with a terminal device 100 used by a plurality of users including users U1 and U2 (hereinafter, referred to as “a user U” when a user is not specified) via a network NW. The network NW includes the Internet, a wide area network (WAN), a local area network (LAN), a public line, a provider device, a dedicated line, a radio base station, and the like. In addition, the management device 300 communicates with the luggage transporting vehicle 200 via the network NW. “The terminal device used by a user” may be a terminal device that can be used by an unspecified large number of people, for example, terminal devices in an internet café, or the like, or may include a terminal device that is temporarily used by a user. In either case, “the terminal device of the user” refers to a terminal device for which the user being operated is specified by, for example, a login operation in which a login name is input.

The user U transmits request information, which requests transportation of luggage P, to the management device 300 using the terminal device 100. In the luggage P, identification information of the luggage P and/or the user U is stated or a label L stored in a built-in IC tag or the like is assigned. “Assigned” means, for example, affixed by a seal.

The terminal device 100 is, for example, a smartphone, a tablet terminal, a personal computer, or the like. In the terminal device 100, an application program, a browser, or the like, for using the above-mentioned service is started and supports a service described below. In the following description, it is assumed that the terminal device 100 is a smart phone and the application program (the transportation service application) for receiving the service is running. The transportation service application communicates with the management device 300 according to an operation of the user, transmits the request information from the user to the management device 300, and provides information based on the information received from the management device 300. The request information is electronic information that requests that the luggage P is transported over a designated section by the luggage transporting vehicle 200.

### [Luggage Transporting Vehicle]

The luggage transporting vehicle 200 includes a monitoring unit 210 such as a camera, a radar device, a LIDAR, or the like, and autonomously travels on the road as described above. A display device 212 may be provided in the luggage transporting vehicle 200. The display device 212 may have a function of a touch panel, or may have an embedded function that communicates with a contactless IC card. The luggage transporting vehicle 200 includes, for example, a plurality of containment parts 240 in which door parts 230 are provided. A containment part unit is constituted by the plurality of containment parts 240.

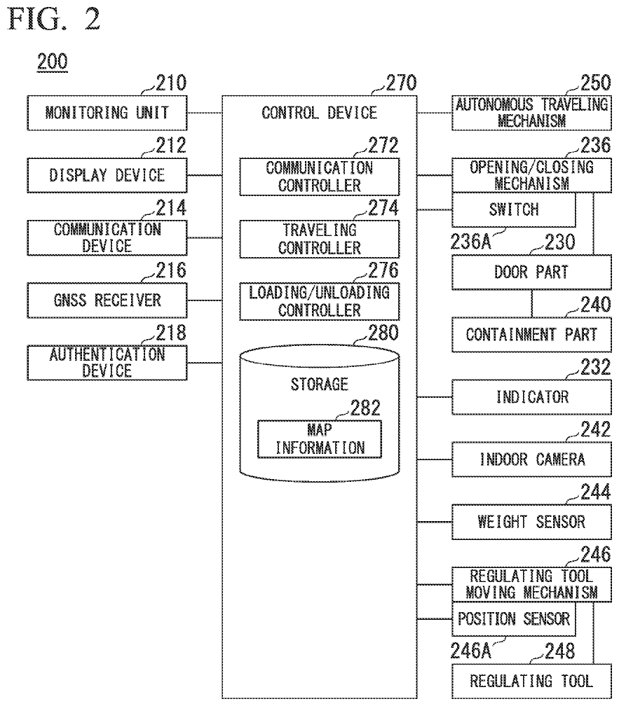

FIG. 2 is a configuration view of the luggage transporting vehicle 200. The luggage transporting vehicle 200 has, in addition to the monitoring unit 210, the display device 212, the door parts 230, the containment parts 240, which are described above, a communication device 214, a GNSS receiver 216, an authentication device 218, an indicator 232, an opening/closing mechanism 236, an indoor camera 242, a weight sensor 244, a regulating tool moving mechanism 246, a regulating tool 248, an autonomous traveling mechanism 250, and a control device 270.

The communication device 214 is, for example, a wireless communication module connected to the network NW or directly communicating with a terminal device or the like of another vehicle or a pedestrian. The communication device 214 performs wireless communication on the basis of Wi-Fi, dedicated short range communications (DSRC), Bluetooth (Registered trademark), and other communication standards. As the communication device 214, a plurality of devices may be provided according to the purpose.

The GNSS receiver 216 measures a position of a host device (a position of the luggage transporting vehicle 200) on the basis of radio waves received from a GNSS satellite (for example, a GPS satellite). The GNSS receiver 216 outputs the positioning result to the control device 270.

The authentication device 218 is a device configured to check whether a user who intends to load the luggage P into the luggage transporting vehicle 200 is a prescribed user (a user has been authenticated). The prescribed user refers to a user who has an agreement (reservation) regarding luggage transportation with the management device 300. The authentication device 218 may be any device as long as it has an authentication function, for example, a short-range wireless communication device, a living body authentication device, a password input device, or the like. The authentication device 218 outputs the authentication result to the control device 270.

The opening/closing mechanism 236 is provided on each of the door parts 230, and includes a link mechanism configured to cause the state of the door part 230 to change an open state or a closed state, and a locking mechanism configured to lock the door part 230 in the closed state. The door part 230 is provided with a knob gripped by a user or the like. When the door part 230 of the containment part 240 used by the user U is unlocked, the indicator 232 (to be described below) lights up, and the user U manually opens and closes the door part 230. The locking mechanism locks the door part 230 when the user closes the door part 230 and the door part 230 is located at a predetermined place.

A switch 236A is attached to the opening/closing mechanism 236. The switch 236A outputs closing information to a loading/unloading controller 276 when the user U closes the door parts 230 and locks the locking mechanism to the door parts 230. The opening/closing mechanism 236 may be a mechanism including a motor, an arm, or the like, and configured to automatically open and close the door part 230 according to, for example, the opening/closing instruction by the loading/unloading controller 276 regardless of an operation of the user U. In this case, the door part 230 is a so-called automatic door. In this case, the switch 236A may simply output the closing information to the loading/unloading controller 276 when the door part 230 is closed.

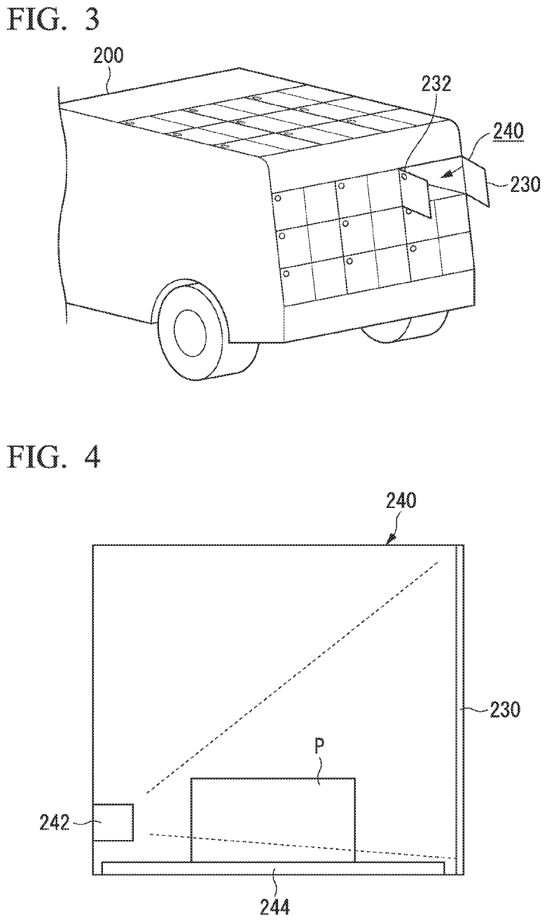

FIG. 3 is a view showing an example of a structure related to the plurality of containment parts 240. The luggage transporting vehicle 200 includes the plurality of containment parts 240. In the configuration shown, nine containment parts 240 that open on the side of the upper surface of the luggage transporting vehicle 200 and nine containment parts 240 that open on the side of the rear surface are provided in the luggage transporting vehicle 200. The door parts 230 are provided on the containment parts 240, respectively. The door parts 230 are opened and closed, for example, in the form of a gatefold cover (hinged double doors), and expose at least some of the containment parts 240 in the open state. The indicators 232 are attached so as to correspond to each of the containment parts 240 (for example, on the side of front surfaces of the door parts 230). The indicator 232 is constituted by, for example, a light emitting diode (LED). The indicator 232 is caused to emit light by the loading/unloading controller 276 so as to display a loading position of the luggage P that is to be loaded, or a position at which the luggage P that is to be unloaded is contained. One piece of luggage P or the luggage P of one user U is made to be contained in each of the disposed containment parts 240. For example, at a luggage collection center, the luggage P contained in containment parts 240 are recognized to whom the luggage P belongs to based on which containment part 240 the luggage P are contained. Further, since a label is assigned to the luggage P by, for example, a worker in the luggage collection center, the destination (unloading point) can be specified in the subsequent flow operation.

FIG. 4 is a view showing an example of an internal structure of the containment part 240. For example, the indoor camera 242 is provided in the containment part 240. The indoor camera 242 is provided on the back side when seen from an exposure part where the door part 230 in the containment part 240 is opened and exposed. The indoor camera 242 is disposed directed in a direction of the exposure part of the containment part 240. The indoor camera 242 captures an image in the containment part 240 from the back side of the containment part 240 according to the imaging instruction of the loading/unloading controller 276. Since the indoor camera 242 is disposed on the back side of the containment part 240, the image captured by the indoor camera 242 is an image obtained by imaging the outside of the luggage transporting vehicle 200 when seen from the containment part 240 together with the inside of the containment part 240. The indoor camera 242 outputs the captured image to the control device 270. The indoor camera 242 is an example of the camera.

For example, the weight sensor 244 is provided on a bottom surface of the containment part 240. The weight sensor 244 is contained in the containment part 240, and measures a weight of the luggage P placed on the weight sensor 244. The weight sensor 244 outputs the weight information according to the measured weight to the control device 270.

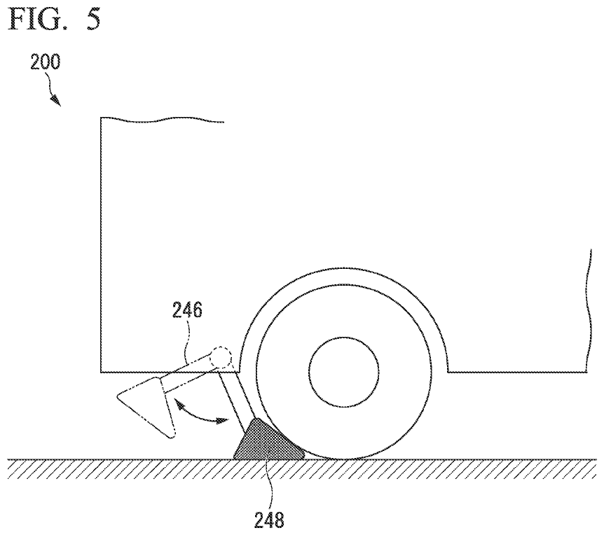

FIG. 5 is a side view showing the regulating tool 248. The regulating tool 248 is a member configured to restrict movement of the luggage transporting vehicle 200 while the vehicle is stopped. The regulating tool 248 is movable between a first position where movement of the luggage transporting vehicle 200 is not restricted (shown by a two-dot dashed line in FIG. 5) and a second position where movement of the luggage transporting vehicle 200 is restricted (shown by a solid line in FIG. 5) by the regulating tool moving mechanism 246. The regulating tool 248 at the second position restricts movement of the luggage transporting vehicle 200. For example, the regulating tool 248 is exposed to the outside in a state in which parking of the luggage transporting vehicle 200 can be clearly recognized from the other people. The regulating tool 248 is, for example, a car stopper configured to stop rotation of a wheel W.

A position sensor 246A is provided on the regulating tool moving mechanism 246. The position sensor 246A detects that the regulating tool 248 is at the second position. The position sensor 246A outputs the restriction information showing that the regulating tool 248 is at the second position and movement of the luggage transporting vehicle 200 is restricted to the loading/unloading controller 276.

The autonomous traveling mechanism 250 includes a wheel, a driving power source such as a motor or the like, an energy accumulation means such as a battery or the like, a steering mechanism, and the like. The autonomous traveling mechanism 250 moves the luggage transporting vehicle 200 in an arbitrary direction according to the instruction from the control device 270.

The control device 270 includes, for example, a communication controller 272, a traveling controller 274, and the loading/unloading controller 276. These components are realized by executing a program (software) using a hardware processor, for example, a central processing unit (CPU) or the like. Some or all of these components may be realized by hardware (a circuit part: including circuitry) such as a large scale integration (LSI), an application specific integrated circuit (ASIC), a field-programmable gate array (FPGA), a graphics processing unit (GPU), or the like, or may be realized by cooperation of software and hardware. The program may be previously stored in a storage device (a storage device including a non-transient recording medium) such as a hard disk drive (HDD), a flash memory, or the like, may be stored in a detachable recording medium (a non-transient recording medium) such as a DVD, a CD-ROM, or the like, or may be installed in a storage device by mounting a recording medium in a drive device. The control device 270 has a storage 280 in which map information 282 is stored. The storage 280 is an HDD, a flash memory, a ROM, a random access memory (RAM), or the like.

The communication controller 272 acquires route information from the management device 300 via the communication device 214, and outputs the acquired route information to the traveling controller 274. The communication controller 272 uploads position information showing a position measured by the GNSS receiver 216 to the management device 300 using the communication device 214. For example, uploading of the position information is periodically performed in milliseconds to seconds.

The traveling controller 274 controls the autonomous traveling mechanism 250 such that the luggage transporting vehicle 200 travels along a route designated by the management device 300. For example, the traveling controller 274 matches the route acquired from the management device 300 with output of the map information 282 and the monitoring unit 210, and determines a route detailed such that the luggage transporting vehicle 200 travels. The traveling controller 274 autonomously travels the luggage transporting vehicle 200 to avoid a contact with an object (including a guard rail, a curbstone, or the like) to which a position or a speed is input from the monitoring unit 210 while driving on the route in principle.

The traveling controller 274 stops the luggage transporting vehicle 200 when the stopping instruction is acquired from the management device 300. Instead of this, when the stopping position information is included in the route information, the traveling controller 274 may stop the luggage transporting vehicle 200 when the positioning result of the GNSS receiver 216 coincides with the stopping position. That is, the information related to the stopping instruction or the stopping position from the management device 300 is provided to the traveling controller 274, and the traveling controller 274 stops the luggage transporting vehicle 200 according thereto. The position at which the luggage transporting vehicle 200 is stopped includes a position on the road. In particular, in a situation in which the user U loads the luggage P into the containment part 240 of the luggage transporting vehicle 200, the luggage transporting vehicle 200 stops on the road, a parking lot, or the like.

The loading/unloading controller 276 drives the indicator 232, the opening/closing mechanism 236, and the regulating tool moving mechanism 246, for example, at a timing instructed from management device 300. The loading/unloading controller 276 operates the regulating tool moving mechanism 246 and moves the regulating tool 248 to the second position, for example, when the luggage transporting vehicle 200 stops on the basis of the stopping instruction transmitted from the management device 300. When the regulating tool 248 is moved to the second position, the position sensor 246A outputs the restriction information to the loading/unloading controller 276. The loading/unloading controller 276 determines whether the regulating tool 248 is disposed at the second position on the basis of presence or absence of the restriction information output from the position sensor 246A. The loading/unloading controller 276 drives the opening/closing mechanism 236 under a condition in which the regulating tool 248 is disposed at the second position. The loading/unloading controller 276 generates stopping information when the regulating tool 248 is disposed at the second position.

The loading/unloading controller 276 acquires stopping information that was generated, an image output from the indoor camera 242, weight information according to a weight output from the weight sensor 244, and closing information output from the switch 236A, when the opening/closing mechanism 236 is driven. The communication controller 272 causes the communication device 214 to transmit the stopping information, the image, the weight information, and the closing information acquired by the loading/unloading controller 276 to the management device 300.

### [Management Device]

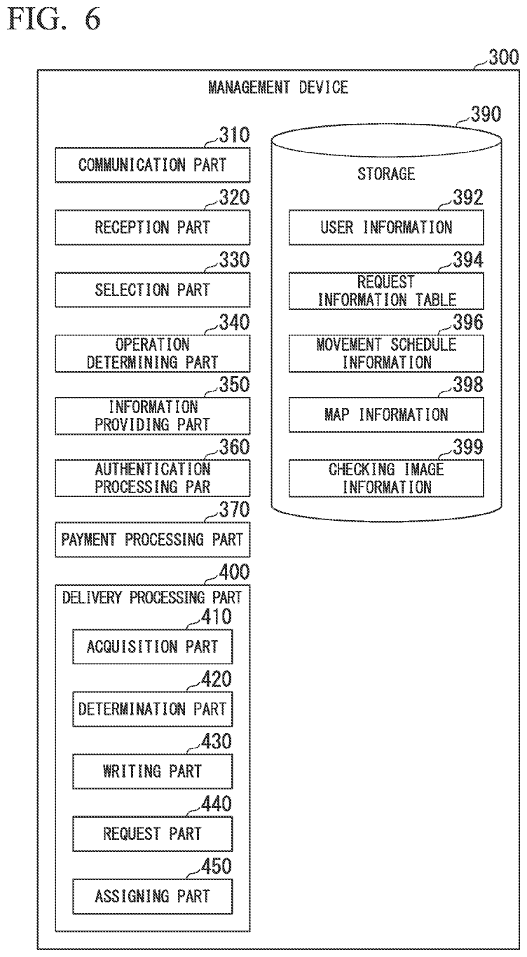

FIG. 6 is a configuration view of the management device 300. The management device 300 includes, for example, a communication part 310, a reception part 320, a selection part 330, an operation determining part 340, an information providing part 350, an authentication processing part 360, a payment processing part 370, and a delivery processing part 400. These components are realized by executing a program (software) using a hardware processor such as a CPU or the like. Some or all of these components may be realized by hardware (a circuit part: including circuitry) such as an LSI, an ASIC, an FPGA, a GPU, or the like, or may be realized by cooperation of software and hardware. The program may be previously stored in a storage device (a storage device including a non-transient recording medium) such as an HDD, a flash memory, or the like, may be stored in a detachable recording medium (a non-transient recording medium) such as a DVD, a CD-ROM, or the like, or may be installed in a storage device by mounting a recording medium in a drive device. The management device 300 may include a storage 390. The storage 390 is realized by a DVD, a random access memory (RAM), a flash memory, or the like. The storage 390 stores user information 392, a request information table 394, movement schedule information 396, map information 398, checking image information 399, or the like. The checking image information 399 contains, for example, a plurality of abnormality checking images written on the storage 390 by a writing part 430, which will be described below.

The user information 392 is, for example, information in which communication identification information, a name, a gender, an age, an address, an occupation, and the like, correspond to a user ID that is identification information of the user U. In the request information table 394, information such as a loading point (a delivery source point, luggage collecting point), a discharge point (a delivery destination point), a delivery desiring time, a luggage type showing a size or a shape of the luggage P, and the like, is registered with respect to each luggage P. The movement schedule information 396 includes information that defines movement of each luggage transporting vehicle 200.

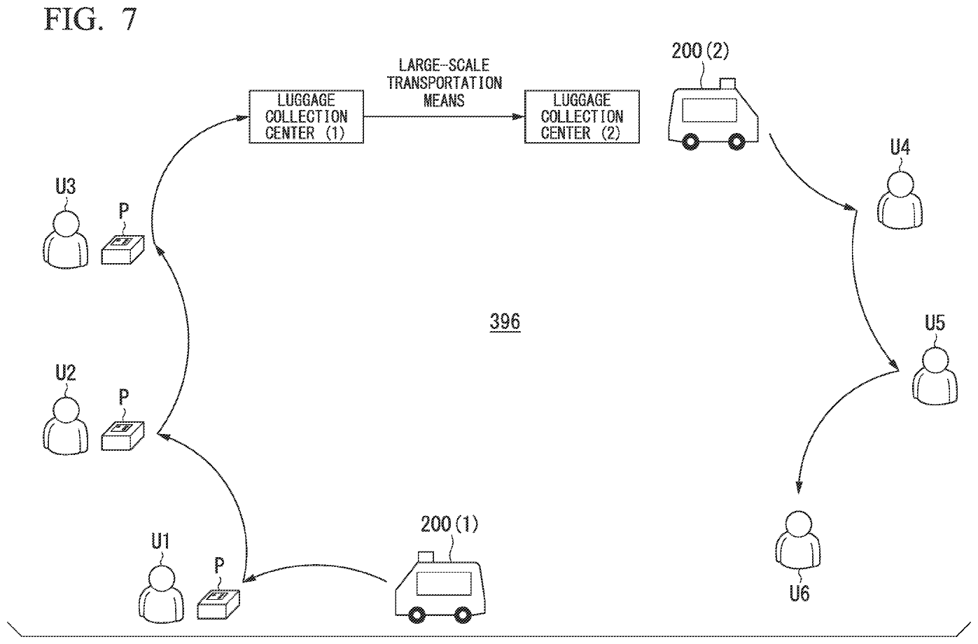

FIG. 7 is a view conceptually showing contents of the movement schedule information 396. As shown, the movement schedule information 396 contains information that defines a series of operations of causing a certain luggage transporting vehicle 200 (1) to pick up the luggage P of the user U1 at a loading point and loading desiring time of the user U1, then, pick up the luggage P of the user U2 at a loading point and loading desiring time of the user U2, then, pick up the luggage P of the user U3 at a loading point and loading desiring time of the user U3, and transport the luggage to a luggage collection center (1). In the luggage collection center, after sorting the collected luggage P by every zone of a delivery destination, a work of transporting the luggage to another luggage collection center is performed. For example, the luggage P is transported by a large-scale transportation means such as a large truck, a railroad, or the like, between the luggage collection centers (in the drawings, from a luggage collection center (1) to a luggage collection center (2)). The movement schedule information 396 may further contain information that defines an operation to deliver the luggage P in sequence of the users U4, U5 and U6 from the luggage collection center (2). Regarding the delivery to the destination after the luggage collection center, for example, as the request information table 394 is retrieved using the label information obtained from the label L as a key, information of the destination (discharge point) is acquired, and the operation of the luggage transporting vehicle 200 (2) is determined based on the information.

Returning to FIG. 6, components of the management device 300 will be described. The communication part 310 is, for example, a network card configured to connect the device to the network NW. The communication part 310 communicates with the terminal device 100 or the luggage transporting vehicle 200 via the network NW. The communication part 310 receives, for example, the stopping information, image, the weight information, and the closing information transmitted from the communication device 214 of the luggage transporting vehicle 200, and outputs the information to an acquisition part 410.

The reception part 320 acquires (receives) the request information emitted from the terminal device 100 of the user U via the communication part 310, and adds the information to the request information table 394. The selection part 330 refers the list (not shown) of the luggage transporting vehicles 200 and the movement schedule information 396 when record of new request information is added to the request information table 394, and selects the luggage transporting vehicle 200 provided for the user U according to the request information from the plurality of luggage transporting vehicles 200.

The operation determining part 340 generates the above-mentioned movement schedule information 396. For example, the operation determining part 340 sets some moving patterns in which a plurality of loading points and loading desiring times are arranged in sequence after the record of the request information is roughly grouped for dates, time zones, and area zones, and refers to the map information 398 so as to extract an optimal moving pattern and add the optimal moving pattern to the movement schedule information 396. Then, the operation determining part 340 transmits an operation instruction to the luggage transporting vehicle 200 using the communication part 310 according to contents described in the movement schedule information 396. The management device 300 manages an operation of the luggage transporting vehicle 200 by transmitting the operation determining part 340 from the operation instruction to the luggage transporting vehicle 200.

The information providing part 350 provides the position information of the luggage transporting vehicle 200 to the terminal device 100 of the user U. The information providing part 350 transmits the position information, which is uploaded with the communication device 214 by the communication controller 272 of the luggage transporting vehicle 200, to the terminal device 100 by using the communication part 310.

The authentication processing part 360 acquires, for example, various pieces of information (password, living body information, token, or the like) acquired by the authentication device 218 of the luggage transporting vehicle 200, and informs the operation determining part 340 of information that authentication is succeeded when the acquired information is justified. In response, the operation determining part 340 transmits the information that instructs the luggage transporting vehicle 200 to open which door part 230.

The payment processing part 370 performs processing for collecting a fare from the user U. For example, the payment processing part 370 works with a management server of credit cards or electronic money, and collects the fare from the user U.

The delivery processing part 400 includes, for example, the acquisition part 410, a determination part 420, the writing part 430, a request part 440, and an assigning part 450. The acquisition part 410 acquires stopping information, image, weight information, and closing information output from the communication part 310, and outputs the information to the determination part 420. The acquisition part 410 outputs the acquired closing information to the assigning part 450.

The determination part 420 selects an image of a situation in which the luggage P is taken out in the acquired image acquired by the acquisition part 410 (hereinafter, referred to as “a determination target image”). The determination part 420 may select the image in any way. The determination part 420 may process, for example, a plurality of images acquired by the acquisition part 410 and select a scene until the image of the luggage ends, or may check an open/closed state of the door part 230 on the basis of the stopping information or the closing information and may select a scene in which the door part 230, which is closed while having the luggage contained inside, is opened and until the door part 230 is closed again.

The determination part 420 performs determination of whether delivery of the luggage P has been completed normally (hereinafter, referred to as “completion determination”) on the basis of the stopping information and weight information together with the determination target image selected from the images acquired by the acquisition part 410. When performing the completion determination, the determination part 420 performs, for example, image processing of the determination target image and tracks the moving luggage P, and detects a state before and after the luggage P is unloaded from the containment part 240. The determination part 420 refers, for example, a variation in weight before and after the luggage P is not shown in the determination target image, and performs the completion determination on the basis of whether the weight relationship coincides with presence or absence of the luggage P.

The determination part 420 may perform completion determination using information other than information such as an image or the like in combination. For example, the determination part 420 may perform completion determination using the tracking and weight information of the luggage P and checking of a recipient by electronic signature in combination. The determination part 420 may perform the completion determination on the condition that the door part 230 is closed.

The determination part 420 causes the communication part 310 to transmit the completion information to the luggage transporting vehicle 200 when it is determined that the delivery of the luggage P has been completed normally. The determination part 420 outputs the determination target image using the completion determination (hereinafter, referred to as “an abnormality checking image”) to the writing part 430 when it is determined that the delivery of the luggage P is abnormal and the delivery of the luggage P is not completed normally. The writing part 430 writes the abnormality checking image output from the determination part 420 on the storage 390 as the checking image information 399.

The request part 440 requests the user or other users than the user (the other users than the user) to close the door part 230 when the door part 230 is open after the delivery of the luggage has been completed. The request part 440 generates request information when requesting the closing of the door part 230. The request part 440 transmits the generated request information to the luggage transporting vehicle 200 using the communication part 310. The luggage transporting vehicle 200 that has received the request information requests another person, for example, the second user U2, a third party (another person), etc., to whom the luggage has been delivered next after the first user U1 has taken out the luggage, to close the door part 230 by using, for example, the display device 212 or a sound output device. The first user U1 is an example of the first user, and the second user U2 is an example of the second user.

The assigning part 450 determines whether a person who closes the door part 230 (hereinafter, referred to as “a closing person”) is the user U who is a recipient of the luggage P when the door part 230 is closed after the closing of the door part 230 is requested to the luggage transporting vehicle 200. The assigning part 450 assigns a benefit as a reward to the closing person when it is determined that the determined closing person is a person other than the user U. The benefit assigned to the closing person is, for example, a coupon or other products which the closing person can use when using the luggage delivery service. The benefit may be available for the luggage delivery service or may be available for other than the luggage delivery service.

### [Processing of Luggage Transporting Vehicle 200]

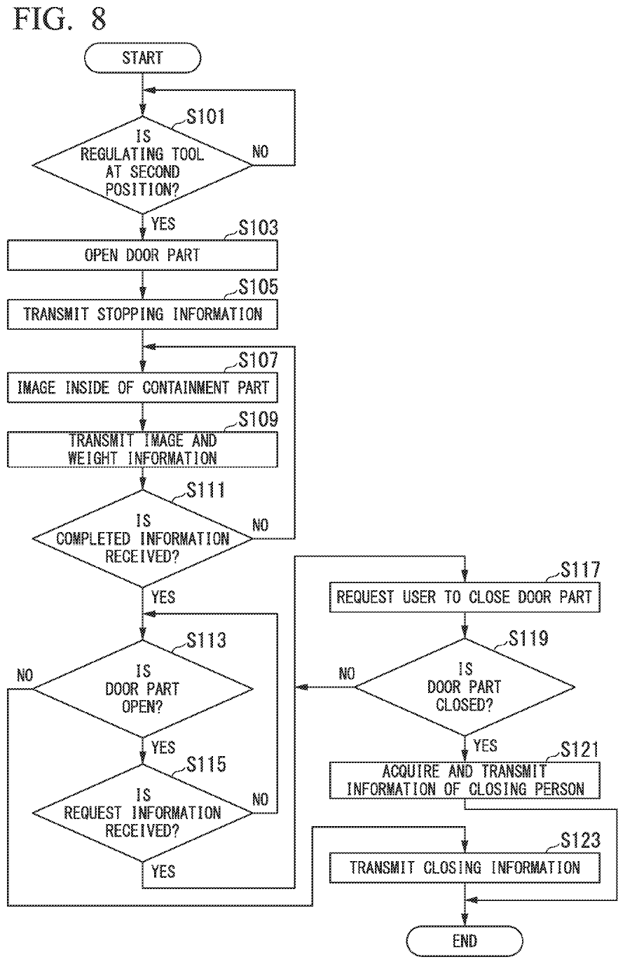

FIG. 8 is a flowchart showing an example of processing of the luggage transporting vehicle 200. In FIG. 8, for example, the processing is executed after the luggage transporting vehicle 200 receives the stopping instruction transmitted from the management device 300 and stops. First, the loading/unloading controller 276 of the luggage transporting vehicle 200 determines whether the regulating tool 248 is at the second position on the basis of presence or absence of the restriction information output from the position sensor 246A (step S101).

When it is determined that the regulating tool 248 is at the second position, the loading/unloading controller 276 opens the door part 230 (step S103). Next, the loading/unloading controller 276 causes the communication device 214 to transmit the stopping information to the management device 300 (step S105). Next, the loading/unloading controller 276 outputs the imaging instruction to the indoor camera 242 and images the inside of the containment part 240 (step S107). Since the indoor camera 242 is disposed on the back side of the containment part 240, the image captured by the indoor camera 242 include images with subjects such as the luggage P, the inside of the containment part 240, the outside of the luggage transporting vehicle 200, the user U who unloads the luggage P, or the like. The loading/unloading controller 276 acquires the image output from the indoor camera 242 and the weight information output from the weight sensor 244.

Next, the loading/unloading controller 276 causes the communication device 214 to transmit the image and weight information acquired by the loading/unloading controller 276 to the management device 300 (step S109). The management device 300 performs the completion determination on the basis of the image information and the weight information transmitted from the luggage transporting vehicle 200. The management device 300 transmits the completion information to the luggage transporting vehicle 200 when it is determined that the delivery has been completed normally as a result of the completion determination. The processing of the management device 300 will be described below.

Next, the loading/unloading controller 276 determines whether the completion information transmitted from the management device 300 is received by the communication device 214 (step S111). When it is determined that the communication device 214 did not receive the completion information, the loading/unloading controller 276 returns to step S107, and repeats the imaging of the inside of the containment part. When it is determined that the communication device has received the completion information, the loading/unloading controller 276 determines whether the closing information is not output from the switch 236A and the door part 230 is in an open state (step S113). When it is determined that the door part 230 is in the open state, the loading/unloading controller 276 determines whether the request information transmitted from the management device 300 is received by the communication device 214 (step S115).

When it is determined that the request information is not received by the communication device 214, the loading/unloading controller 276 returns to step S113 and determines whether the door part is open. When it is determined that the request information is received by the communication device 214, the loading/unloading controller 276 requests the user U to close the door part 230 using the display device 212 or the sound output device (step S117). The loading/unloading controller 276 requests the second user U2 who has received the luggage next after the user U, a third party (another person), or the like, to close the door part 230 when the user U is not nearby.

Next, the loading/unloading controller 276 determines whether the door part 230 is closed (step S119). When it is determined that the door part 230 is not closed, the loading/unloading controller 276 returns to step S117 and continuously requests the user to close the door part 230. When it is determined that the door part 230 is closed, the loading/unloading controller 276 acquires the information of the user who has closed the door part 230, and causes the communication device 214 to transmit the information to the management device 300 (step S121). The information of the user who has closed the door part 230 is, for example, images including the user imaged by the indoor camera 242 or various pieces of information or the like acquired by the authentication device 218. In this way, the luggage transporting vehicle 200 terminates the processing shown in FIG. 8.

In step S113, when it is determined that the door part 230 is closed and do not remain open, the loading/unloading controller 276 causes the communication device 214 to transmit the closing information to the management device 300 (step S123). In this way, the luggage transporting vehicle 200 terminates the processing shown in FIG. 8.

### [Processing of Management Device 300]

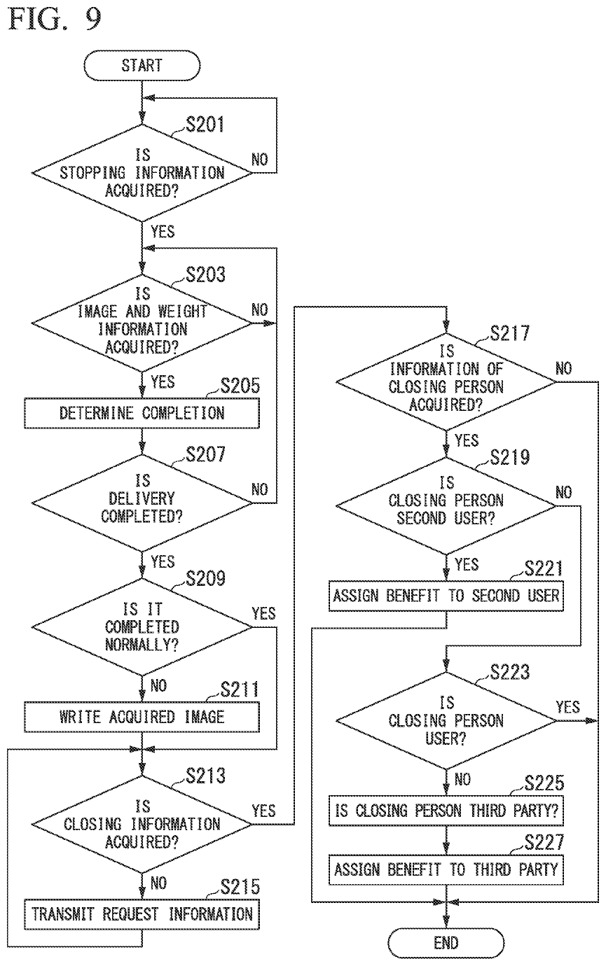

FIG. 9 is a flowchart showing an example of the processing of the delivery processing part 400. The delivery processing part 400 determines whether the stopping information transmitted from the luggage transporting vehicle 200 is acquired by the acquisition part 410 in the determination part 420 (step S201). When it is determined that the stopping information is not acquired by the acquisition part 410, the determination part 420 repeats the processing of step S201.

When it is determined that the stopping information is acquired by the acquisition part 410, the determination part 420 determines whether the image and weight information transmitted from the luggage transporting vehicle 200 is acquired (step S203). When it is determined that the image and weight information is not received, the determination part 420 repeats the processing of step S203.

When it is determined that the image and weight information is received, the determination part 420 performs the completion determination (step S205). In performing the completion determination, the determination part 420 selects the determination target image from a plurality of images when the plurality of images are acquired by the acquisition part 410. When the luggage transporting vehicle 200 transmits the determination target image only, the determination part 420 omits selection of the image. The completion determination is executed on the condition that the stopping information is acquired.

The determination part 420 performs the completion determination on the basis of the selected image and the weight information. The determination part 420 determines that the delivery has been completed, for example, when the luggage P is not captured in the image finally (condition 1) and the weight indicated by the weight information is 0 or a small value close to 0 (condition 2). For example, it may be determined that the delivery has been completed when one of the above-mentioned conditions 1 and 2 is established.

Next, the determination part 420 determines whether the delivery has been completed (step S207). When it is determined that the delivery is not completed, the determination part 420 returns to step S203, and performs determination of whether the image and weight information is acquired. The determination part 420 temporarily stores the image and weight information acquired until the completion determination is terminated on the storage 390 after the completion determination is performed, and eliminates the information according to necessity. In the determination part 420, in addition to the image acquired in step S205, the image stored in the storage 390 before elimination is also used as the determination target image.

When it is determined that the delivery has been completed, the determination part 420 determines whether the delivery has been completed normally (step S209). The determination of whether the delivery is normally completed is determined by, for example, whether the image in which the authenticated user U retrieves the luggage from the containment parts 240 is contained in the determination target image and the weight indicated by the weight information is 0 or the like. Then, for example, when the above-mentioned conditions 1 and 2 are satisfied but the image in which a person other than the user U retrieves the luggage P is contained in the determination target image, it is determined that the delivery has been completed but not completed normally.

When it is determined that the delivery has been completed normally, the determination part 420 proceeds to step S213 directly. When it is determined that the delivery is not completed normally, the writing part 430 writes an abnormality checking image temporarily stored in the storage 390 as the checking image information 399 in the storage 390 (step S211).

Next, the determination part 420 determines whether the acquisition part 410 acquires the closing information until a predetermined time elapses after the delivery has been completed (step S213). When it is determined that the acquisition part 410 does not acquire the closing information, the request part 440 generates request information and causes the communication part 310 to transmit the generated request information to the luggage transporting vehicle 200 (step S215), and the determination part 420 repeats the processing of step S213.

When it is determined that the acquisition part 410 acquires the closing information, the assigning part 450 determines whether the information of the closing person transmitted from the luggage transporting vehicle 200 is acquired by the acquisition part 410 (step S217). When it is determined that the acquisition part 410 does not acquire the information of the closing person, the delivery processing part 400 terminates the processing shown in FIG. 9.

When it is determined that the acquisition part 410 acquires the information of the closing person, the assigning part 450 determines where the closing person is the second user U2 (step S219). When it is determined that the closing person is the second user U2, the assigning part 450 assigns a benefit such as a coupon with respect to use of a luggage delivery service to the second user (step S221).

When it is determined that the closing person is not the second user U2, the assigning part 450 determines whether the closing person is a user (step S223). When it is determined that the closing person is the user, the assigning part 450 does not assign the benefit to the user, and the delivery processing part 400 terminates the processing shown in FIG. 9. The assigning part 450 may assign the benefit when the closing person is the user.

When it is determined that the closing person is not the user, the assigning part 450 determines that the closing person is a third party (step S225). Next, the assigning part 450 assigns a benefit or the like that can be used for other than the luggage delivery service to the third party who is the closing person (step S227). Since the third party is not the user who uses the luggage delivery service, it is preferable that the benefit assigned to the third party is a benefit that can be used for other than the delivery service. In this way, the delivery processing part 400 terminates the processing shown in FIG. 9.

The management device 300 of the embodiment determines whether the delivery of the luggage P has been completed normally on the basis of the image captured by the indoor camera 242 mounted on the luggage transporting vehicle 200. For this reason, since it can be easily checked that the delivery of the luggage P has been completed normally, convenience can be improved.

The management device 300 of the embodiment determines whether the delivery of the luggage P has been completed normally on the basis of the weight of the contained substance in the containment parts 240 detected by the weight sensor 244 together with the image captured by the indoor camera 242. For this reason, since it can be accurately checked that the delivery of the luggage P has been completed normally, convenience can be improved.

The management device 300 of the embodiment writes the abnormality checking image in the storage 390 when the delivery of the luggage P is not completed normally. For this reason, when the luggage P in the containment part 240 is taken away by, for example, a person other than the user at the delivery destination, since the person who took away the luggage P can be imaged, fraudulent can be prevented. For example, when the abnormality checking image is written when the delivery of the luggage P is not completely normally, and the writing is omitted when the delivery of the luggage P has been completed normally. For this reason, since writing processing is not performed in a situation in which there is little need, the processing burden on the management device 300 can be reduced.

The management device 300 of the embodiment performs determination in the determination part 420 when movement of the luggage transporting vehicle 200 is restricted by the regulating tool 248. For this reason, since the determination in the determination part 420 is performed when delivery of the luggage in the luggage transporting vehicle 200 is executed, it is possible to determine whether the delivery of the luggage P has been completed normally in a situation in which the determination is highly necessary.

### Second Embodiment

Hereinafter, a second embodiment will be described.

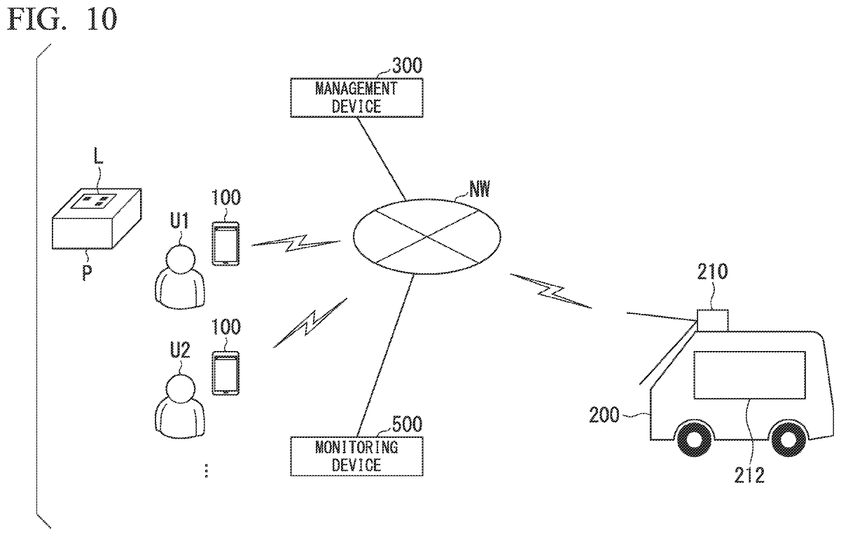

FIG. 10 is a configuration view of a transportation system 2 including a management device 300 according to the second embodiment. The transportation system 2 includes one or more luggage transporting vehicles 200, a management device 300, and a monitoring device 500. The luggage transporting vehicle 200 and the management device 300 have the same configurations as those of the first embodiment. The monitoring device 500 is provided on a delivery base such as a delivery source point or the like. The monitoring device 500 is operated by an operator of the transportation base upon emergency, for example, when there is a problem in managing the operation of the luggage transporting vehicle 200 by the management device 300, or the like.

The monitoring device 500 communicates with the luggage transporting vehicle 200 and the management device 300 via the network NW. The management device 300 transmits the operation instruction transmitted to the luggage transporting vehicle 200 to also the monitoring device 500. The luggage transporting vehicle 200 uploads the position information, which is uploaded to the management device 300, also to the monitoring device 500. The monitoring device 500 monitors management of the operation of the luggage transporting vehicle 200 by the management device 300 on the basis of the operation instruction transmitted from the management device 300 and the position information uploaded by the luggage transporting vehicle 200.

The monitoring device 500 has the same function as that of the traveling controller 274 provided in the luggage transporting vehicle 200. The monitoring device 500 transmits the operation information to the luggage transporting vehicle 200 and controls the autonomous traveling mechanism 250 such that, for example, the luggage transporting vehicle 200 travels along the route designated to the luggage transporting vehicle 200 by the management device 300 when there is a problem in managing the operation of the luggage transporting vehicle 200 by the management device 300. The monitoring device 500 remotely operates the luggage transporting vehicle 200 by controlling the autonomous traveling mechanism 250 when there is a problem in managing the operation of the luggage transporting vehicle 200 by the management device 300. The monitoring device 500 is an example of the external control device.

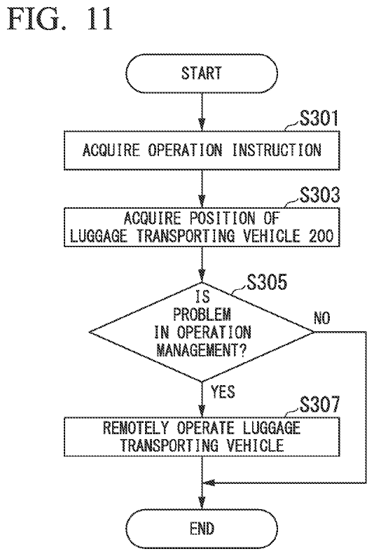

FIG. 11 is a flowchart showing an example of processing of the monitoring device 500. The monitoring device 500 acquires the operation instruction transmitted from the management device 300 (step S301). The operation instruction acquired by the monitoring device 500 is the same as the operation instruction transmitted to the luggage transporting vehicle 200 by the management device 300.

Next, the monitoring device 500 receives the position information uploaded by the luggage transporting vehicle 200, and acquires a position of the luggage transporting vehicle 200 on the basis of the received position information (step S303). Next, the monitoring device 500 determines whether there is a problem in managing the operation of the luggage transporting vehicle 200 by the management device 300 (step S305). The monitoring device 500 determines that there is no problem in management, for example, when the position of the luggage transporting vehicle 200 is a position corresponding to the operation instruction of the management device 300. The monitoring device 500 determines that there is a problem in management when the position of the luggage transporting vehicle 200 is not the position corresponding to the operation instruction of the management device 300.

When it is determined that there is no problem in managing the operation of the luggage transporting vehicle 200, the monitoring device 500 terminates the processing shown in FIG. 11. When it is determined that there is a problem in managing the operation of the luggage transporting vehicle 200, the monitoring device 500 generates the operation information on the basis of the operation instruction transmitted from the management device 300. The monitoring device 500 remotely operates the luggage transporting vehicle 200 by transmitting the generated operation information to the luggage transporting vehicle 200 and controlling the autonomous traveling mechanism 250 (step S307). In this way, the monitoring device 500 terminates the processing shown in FIG. 11.

In the second embodiment, while the monitoring device 500 may be provided separately from the management device 300, a part of the management device 300 may function as the monitoring device 500. In this case, in the management device 300, for example, when there is a problem in managing the operation of the luggage transporting vehicle 200, when the operation instruction with respect to the luggage transporting vehicle 200 in the operation determining part 340 cannot be generated, the management device 300 may generate an operation instruction according to the operation of the operator and transmit the operation instruction to the luggage transporting vehicle 200.

### [Other Aspects]

In each of the embodiments, in the loading/unloading controller 276, while the inside of the containment parts 240 is imaged by the indoor camera 242 when the door part 230 is open, the inside of the containment part 240 may be imaged by the indoor camera 242 even when the door part 230 is not open. In this case, the loading/unloading controller 276 may transmit only the image captured when the door part 230 is open, for example, among the captured image, to the management device 300. For example, the loading/unloading controller 276 may image only the containment part 240 in which the luggage P is contained using the indoor camera 242.

In each of the embodiments, while the abnormality checking image is imaged by the indoor camera 242, the other imaging device, for example, the abnormality checking image may be imaged by a camera provided in the monitoring unit 210. In each of the embodiments, while the image is imaged by the indoor camera 242, instead of or in addition to the image, the indoor camera 242 may be configured to image moving pictures. The management device 300 may be able to detect that the user U has forgotten to unload entire or a part of the luggage P and may be able to detect that the user U has thrown in a foreign substance such as trash or the like after unloading the luggage P, on the basis of the image and weight information transmitted from the luggage transporting vehicle 200. For example, the management device 300 may write the image of the indoor camera 242 on the storage 390 when it is detected that the luggage P is forgotten or the foreign substance is thrown in.

In each of the embodiments, while the management device 300 is provided independently from the luggage transporting vehicle 200, some or all of the functions of the management device 300, for example, the delivery processing part 400 (the delivery processing function) may be provided in the luggage transporting vehicle 200. In this case, for example, some or all of the functions of the control device 270, for example, the function of the loading/unloading controller 276 may be provided in the management device. The indoor camera 242 may be disposed at a position where the plurality of containment parts 240 can be imaged. In this case, a partition (wall) that partitions the containment parts 240 may be transparent, or an opening may be formed in the partitions.

According to the above-mentioned first embodiment, convenience can be improved.

According to the above-mentioned second embodiment, in addition to exhibition of the same effect as the first embodiment, the luggage transporting vehicle 200 can be operated even when the management device 300 malfunctions.

The above-mentioned embodiment can be expressed as described below.

A management device configured to manage an operation of a luggage transporting vehicle autonomously traveling along a road without a driver getting on and including a luggage containment part shielded by a door part that is able to be opened and closed, the management device including:

a storage device in which a program is stored; and

a hardware processor,

wherein, as the hardware processor executes the program,

an image obtained by imaging the inside of the containment part is acquired, and

whether delivery of luggage contained in the containment part has been completed is determined on the basis of the image.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A management device configured to manage an operation of a luggage transporting vehicle, the luggage transporting vehicle being configured to autonomously travel a road without a driver being aboard and comprising a luggage containment part which is shielded by a door part that is able to be opened and closed, the management device comprising:
an acquisition part configured to acquire an image of an inside of the containment part; and
a determination part configured to determine whether a delivery of a luggage contained in the containment part has been completed normally on the basis of the image.

2. The management device according to claim 1, further comprising a writing part configured to write the image of a scene in which the luggage has been unloaded into a storage, among the images acquired by the acquisition part.

3. The management device according to claim 2, wherein the writing part does not perform writing of the image when the determination part determines that the delivery has been completed normally.

4. The management device according to claim 1, wherein the acquisition part acquires weight information related to a weight of the luggage contained in the containment part, and
the determination part determines whether delivery of the luggage contained in the containment part has been completed normally also on the basis of the weight information acquired by the acquisition part.

5. The management device according to claim 1, wherein the determination part determines whether delivery of the luggage contained in the containment part has been completed normally when a movement of the luggage transporting vehicle is restricted by a regulating tool.

6. A transportation system comprising the management device and the luggage transporting vehicle according to claim 1,
wherein the luggage transporting vehicle comprises a camera configured to image the inside of the containment part, and generates an image captured by the camera and outputs the image to the management device.

7. The transportation system according to claim 6, further comprising: an external control device that is provided outside the luggage transporting vehicle and that is configured to transmit operation information to the luggage transporting vehicle and remotely control the luggage transporting vehicle,
wherein the external control device remotely operates the luggage transporting vehicle when there is a problem in a managing of the operation of the luggage transporting vehicle by the management device.

8. The transportation system according to claim 6, comprising: a request part configured to request closing of the door part provided in the containment part in which the luggage was contained, when the delivery of the luggage has been completed,
wherein, when a first user who has unloaded the luggage from the containment part did not close the door part, the request part requests a second user to whom a luggage was delivered next after the first user to close the door part.

9. The transportation system according to claim 6, comprising:
a request part configured to request closing of the door part provided in a containment part in which luggage was contained, when the delivery of the luggage has been completed; and
an assigning part configured to assign a reward to a person who has closed the door part,
wherein, when an user who has unloaded the luggage from the containment part did not close the door part, the request part requests another person other than the user to close the door part, and
the assigning part assigns the reward to the another person when the another person has closed the door part in response to the request of the request part.

10. A management method of a management device, the management device being configured to manage an operation of a luggage transporting vehicle which autonomously travels a road without a driver being aboard and which comprises a luggage containment part shielded by a door part that can be opened and closed, the management method comprising operation controls of the management device in which:
acquiring an image obtained by imaging the inside of the containment part; and
determining whether a delivery of a luggage contained in the containment part has been completed on the basis of the image.

11. A computer-readable recording medium on which a program is stored, the program comprising operation controls of a management device, which is configured to manage an operation of a luggage transporting vehicle that autonomously travels a road without a driver being aboard and that comprises a luggage containment part shielded by a door part that can be opened and closed, in which:
acquiring an image obtained by imaging the inside of the containment part; and
determining whether a delivery of a luggage contained in the containment part has been completed on the basis of the image.
